(19) United States
(12) Patent Application Publication
(10) Pub. No.: US 2004/0156425 A1
(43) Pub. Date: Aug. 12, 2004

(54) Reduction of effects of spurious correlations in ranging receivers

(76) Inventors: Allan Manz, Airdrie (CA); Joseph Angelo, Calgary (CA)

Correspondence Address: CESARI AND MCKENNA, LLP, 88 BLACK FALCON AVENUE, BOSTON, MA, 02210, US

(21) Appl. No.: 10/365,092

(22) Filed: Feb. 12, 2003

(51) Int. Cl. H04K 1/00; H04B 1/69; H04B 1/707; H04B 1/713; H04B 15/00; H04L 27/30

(52) U.S. Cl. 375/150; 375/142

(57) ABSTRACT

A position-estimating receiver, that receives ranging signals that are transmitted by multiple sources that modulate the signals with pseudo-random unique to the respective sources, includes data correlation channels, each of which correlates the incoming signals with a replica of the code used by a selected source to acquire the signal from the source in an acquisition mode and tracking the acquired signal in a tracking mode. The receiver detects possible spurious correlations in one or more monitor channels, each of which correlates the incoming signals with the code replica in use by a data channel in the tracking mode, stepping the replica through a succession of code phases other than the phase in the data channel and, if a significant correlation output is detected, causes the data channel to return to the acquisition mode.

### BACKGROUND OF THE INVENTION

1. Field of the Invention

This invention relates to a system for detecting spurious tracking of ranging signals such as those transmitted by GPS satellites. More particularly it relates to detection of a tracking of a signal other than the one that a receiver has identified as being tracked.

2. Background Information

As is well known, the global positioning system (GPS) comprises a number of earth-orbiting satellites that transmit coded signal sequences. An earth-based receiver can ascertain its position by comparing the relative timing of the signals received from four satellites. Ordinarily, more than four satellites are in view of the receiver and the redundancy of the received signals can be used to enhance the accuracy of position determination. However, in some cases a receiver may track the signal from one satellite when the operation of the receiver has indicated that it is tracking the signals from a different satellite. This results in an erroneous position estimate and the present invention is directed to the swift detection of these conditions.

All the satellites in a ranging system such as GPS transmit on the same carrier frequency, with each satellite phase-modulating the carrier with a pseudo-random code unique to that satellite. Each receiver includes multiple data correlation channels, each of which is controlled to “acquire” the signal from a selected satellite. Specifically, the channel attempts to correlate with the incoming signals, a local replica of the code used by the satellite. If the signal from the satellite is acquired, the channel then tracks the signal by maintaining the local code replica in synchronism with the code in the acquired signal.

To accomplish acquisition, the channel steps the code replica through successive phases, relative to the code transmitted by the satellite. If the correlation process yields an output greater than a predetermined threshold level in one of the code phases, acquisition has been accomplished.

Ideally, the acquisition process provides a substantial correlation output corresponding to the signal from the selected satellite and a negligible output corresponding to signals from the other satellites. Indeed this would be case if the codes were truly random. However, they are limited in length. For example, in the case of the C/A commercial GPS system they have a length of 1023 chips and the codes are far from random. It is possible, therefore, to obtain a substantial spurious correlation output from the signal transmitted by a satellite other than the selected one.

If the strengths of the signals received from the two satellites are equal and have zero relative Doppler offset correlation with the signal from the selected satellite will produce a correlation output power at least 24 dB greater than the power resulting from a spurious correlation with the signal from any other satellite. However the signal strength of the selected satellite may be degraded by a number of factors such as partial obstruction by terrain features, multi path interference, etc. In such cases, the strength of the signal from another satellite may exceed that from a selected satellite sufficiently that the output power of the spurious correlation is close to or even exceeds that of the selected satellite. The receiver may thus acquire and track the signals from a satellite even though the local code replica used by the receiver is identified with a different satellite. This results in an erroneous estimate of the position of the receiver.

The receiver can be configured to ultimately identify the satellite being tracked and correct the error. However, the error may persist too long for use of the receiver in a fast-responding control system that relies on the position information generated by the receiver.

A number of techniques have been proposed to deal with this problem. For example, receiver may be configured to reject all satellite signals having a carrier-noise density ratio (C/N₀) below a prescribed threshold level. Unfortunately, this prevents the receiver from using ranging data from all weak signals, thus reducing the accuracy of position estimates. Another technique used to avoid spurious correlations with satellite signals is to reject acquisition of signals that have the same Doppler frequency offset as a satellite signal already being tracked, since it is unlikely that two satellites will have the same receiver-directed velocity components. Again, this arrangement rejects useful data in those cases where the signals from two satellites have close Doppler offsets.

Moreover, neither of these approaches solves the problem of shifting to a spurious correlation during tracking. When a receiver has acquired the signal from a satellite and has entered the tracking mode for that signal, it substantially reduces the C/N₀ threshold so that it can continue using the signal from that satellite under varying conditions. This makes it possible for the receiver to “skip” and begin tracking a spurious correlation peak.

Spurious tracking can also result from correlation of a satellite signal with a local code replica that is the correct replica but is time shifted by a substantial number of chips from the received code. Since the signal strengths are the same for the correct and spurious correlation, the spurious correlation always provides an output power substantially less than that of the correct correlation. Acquisition with incorrect code timing can thus always be avoided by running the acquisition search through enough code phases to ensure detection of the correct correlation. However, conventional receivers are not configured to operate in this manner. Moreover, again this would not prevent shifting to the spurious correlation during tracking.

### SUMMARY OF THE INVENTION

A receiver incorporating the invention includes at least one, and preferably two or more, additional correlation channels that monitor the data correlation channels in the tracking mode for possible spurious correlations. For each such data channel in which a spurious correlation is possible, e.g., the ratio (C/N₀) is less than 40 dB-Hz in the present example, a monitor channel is assigned the code replica used in the data channel, aligns its code replica with that of the data channel and records the correlator output power. It then steps the timing of the code replica through a range centered on the correlation peak that is being tracked by the data channel. If it detects another correlation peak of significant amplitude, e.g., greater than 5 dB less than the amplitude of the tracked correlation peak, such that there is a substantial probability that the data channel is tracking with a spurious correlation. The receiver therefore causes the data channel to cease tracking and return to the acquisition mode. In the present GPS system, when the receiver is tracking a C/A correlation peak, there is at least one other correlation peak within any 46-chip range in the code chips when correlating against the correct code or a different code. Therefore, the search for other correlation peaks can be limited to a band of 46 chips that, for simplicity of operation, is initially aligned with the current signal tracking.

With this arrangement the possibility of spurious tracking can be detected very quickly, so that a control system relying on position information provided by the receiver will not be unduly affected by the erroneous data generated by tracking of spurious correlation peaks.

The invention is readily implemented in existing receivers, which can be modified by means of software updates to operate as described herein.

### BRIEF DESCRIPTION OF THE DRAWINGS

The invention description below refers to the accompanying drawings, of which:

FIG. 1 is a diagram of a receiver incorporating the invention; and

FIG. 2 is a flowchart of the operation of the spurious-correlation detector used in the receiver.

### DETAILED DESCRIPTION OF AN ILLUSTRATIVE EMBODIMENT

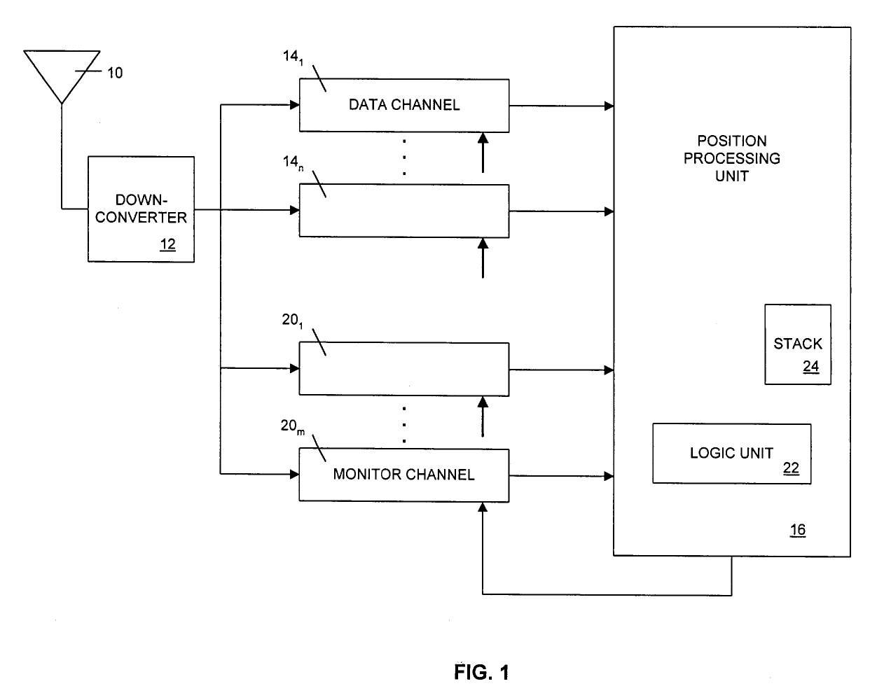

As shown in FIG. 1 a receiver incorporating the invention includes an antenna 10, a down-converter 12 that translates incoming satellite ranging signals to an intermediate frequency, a plurality of data correlation channels 14₁ . . . 14ₙ, and a position processing unit 16. In a well-known manner each of the data correlation channels acquires the signal from a satellite and then tracks the signal to provide ranging data to the position processing unit 16. The unit 16 also provides overall control of the correlation channels, such as assigning them to the signals from particular satellites and providing them with a central clock signal.

The foregoing elements of the receiver and their operation are well known. However, in accordance with the invention, the receiver also includes a spurious-correlation detector comprising one or more monitor correlation channels 20₁ . . . 20ₘ and a logic unit 22, preferably incorporated into the processing unit 16, that controls the operation of these channels. The receiver is also modified to include a stack register 24 that contains a list of the identities of the data channels 20 that are in the tracking mode, the identities of the corresponding code replicas and the identities of the corresponding data channels 14. The processing unit 16 maintains and updates the contents of the register 24 as various data channels 14 move into and out of the tracking mode.

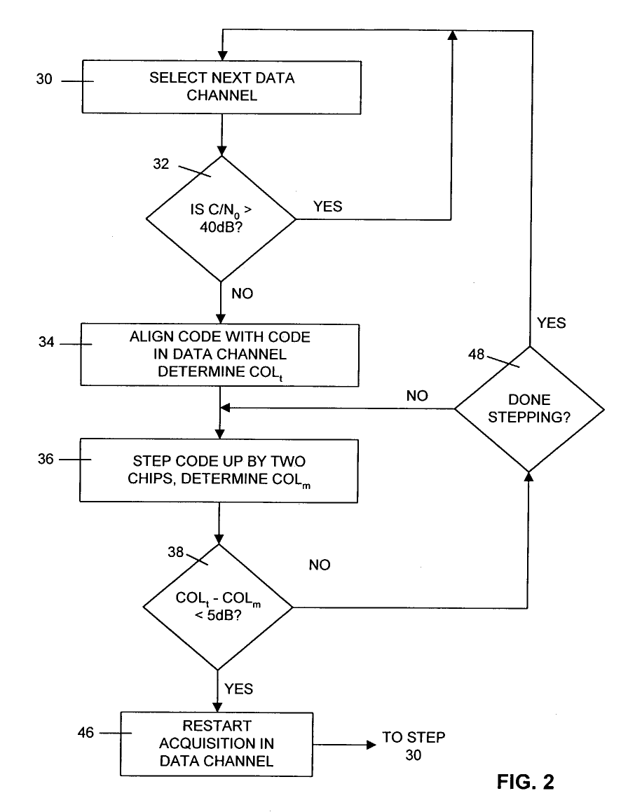

The logic unit 22 is configured to operate in accordance with the flowchart depicted in FIG. 2. Specifically, at step 30, the logic unit retrieves from the top of the list in the register 24 the identity of a data channel in the tracking mode and moves that identity to the bottom of the list. In step 32 it checks the signal-noise density ratio C/N₀ in that channel and, if it is greater than a predetermined figure, e.g. 40 dB-Hz, it returns to step 30. If the ratio is less than or equal to the predetermined figure, the process continues to step 34 in which it assigns to the monitor channel the code replica of the tracked satellite signal, brings that replica into alignment with the code replica in the selected data channel and records the correlation output level COLₜ.

Next, in step 36, the procedure begins stepping the timing of the code replica in the monitoring channel through a range in which correlations other than the one being tracked in the monitored data channel might be encountered, e.g., in the present example, 46 chips later than, the code position in the data channel. Stepping continues until either another correlation is encountered or the range is exhausted without detection of another correlation. Moreover, some receivers are configured to check for two peaks at the same time. In that case, the timing of the code replica can be stepped in two-chip increments.

Specifically, after the code replica has been stepped by two chips, the system, in step 38, compares the correlation output level COLₘ with COLₜ. If COLₜ exceeds COLₘ by less than 5 dB, there is an assumption of significant probability that the data channel is tracking a spurious correlation. In step 44, therefore, the receiver restarts the acquisition process in the data channel and returns the monitor channel to step 30.

If COLₜ exceeds COLₘ by at least 5 dB, the process branches to step 48, in which the logic unit 22 checks whether the entire stepping range (+46 chips) has been covered. If it has, the monitor channel is returned to step 30; otherwise the process returns to step 36.

The time required to detect spurious tracking is materially reduced by the foregoing procedure. Furthermore, the monitor channels may have the same hardware configuration as the data channels and the invention can thus be readily implemented in existing receivers by means of software modifications.

It should be understood that the threshold levels in steps 32 and 38 can be varied, depending on the system in which the invention is incorporated and the characteristics of the signals transmitted by the satellites. Lengthening the duration over which data is gathered at each single chip offset reduces that noise in the measurement. This increases the length of time it takes to complete the test over the range of 46 chips. However, the increased accuracy that results allows the detection threshold to be reduced and permits signal tracking in conditions in which the C/No is reduced. The selection of the threshold and dwell time at each offset is thus a compromise that is selected to suit the requirements of a particular application.

What is claimed is:

1. A receiver for processing signals transmitted by multiple sources that modulate their signals with unique pseudo-random codes unique to the respective sources, said codes being characterized by the presence of significant cross-correlations of at least some of the codes, the receiver comprising:
(A) a plurality of data correlation channels, each data channel having
(1) an acquisition mode in which it acquires the signal from one of said sources by correlating with the received signals a local replica of the code unique to that source, and
(2) a tracking mode in which it tracks the code in the acquired signal;
(B) at least one monitor correlation channel having a mode in which it correlates the signals from said source with local code replicas; and
(C) control means for
(1) causing each monitor channel to
(a) use the code replica used in a selected data channel that is in the tracking mode, and
(b) step the code replica in the monitor channel through a range of code phases in which a significant cross-correlation is possible, and
(2) if a significant correlation output level is encountered in the monitor channel in a replica position other than that in the data channel, shifting the data channel to the acquisition mode.

2. The receiver of claim 1 in which the control means selects only those data channels in which the carrier-noise density ratio is less than a predetermined level.

3. The receiver of claim 1 in which a significant correlation output level is one which is no less than a predetermined level less than the correlation output in the selected data channel.

4. The receiver of claim 1 in which said control means cyclically monitors all of said data channels.

5. A method of limiting the effect of spurious correlations in a receiver that processes ranging signals transmitted by multiple sources that modulate the signals with unique pseudo-random codes, the receiver having a plurality of data correlation channels, each of which has (i) an acquisition mode in which it acquires the signal received from one of said sources by correlating the received signal with a local replica of the code unique to that source, and (ii) a tracking mode in which it tracks the code in the acquired signal, the method comprising:
(A) selecting a data channel that is in the tracking mode;
(B) correlating, in a monitor channel other than the selected data channel, the received signals with the code replica used in the selected data channel;
(C) stepping the phase of the code replica in the monitor channel through a range of replica code phases other than the replica code phase in the selected data channel until either
(1) a significant correlation is encountered in the monitor channel, or
(2) no significant correlation has been encountered in the range of replica code phases in which a significant correlation might be encountered; and
(D) if a significant correlation is encountered in the monitor channel, shifting the selected data channel to the acquisition mode.
